(19) United States
(12) Patent Application Publication
(10) Pub. No.: US 2010/0171878 A1
(43) Pub. Date: Jul. 8, 2010

(54) SYSTEMS AND METHODS FOR SELECTING AND DISPLAYING VIDEO CONTENT

(75) Inventors: Luke VanDuyn, Highlands Ranch, CO (US); Matthew Coburn, Denver, CO (US); Karen Michelle Taxier, Highlands Ranch, CO (US); Daniel L. Rudolph, Castle Rock, CO (US)

Correspondence Address: EchoStar Technologies, L.L.C.;Legal Department, 9601 SOUTH MERIDIAN BOULEVARD, ENGLEWOOD, CO, 80112, US

(73) Assignee: ECHOSTAR TECHNOLOGIES L.L.C., Englewood, CO (US)

(21) Appl. No.: 12/415,474

(22) Filed: Mar. 31, 2009

Related U.S. Application Data
(60) Provisional application No. 61/143,101, filed on Jan. 7, 2009.

(51) Int. Cl. H04N 5/50

(52) U.S. Cl. 348/569; 348/E05.097

(57) ABSTRACT

A television receiver displays television receiver menu information simultaneously with a video stream in an integrated display screen. From within the display screen, the user can select the video stream to close the menu information and display the video stream the television programming in a full screen mode.

### RELATED APPLICATIONS

This application claims priority to U.S. patent application Ser. No. 61/143,101, entitled “SYSTEMS AND METHODS FOR SELECTING AND DISPLAYING VIDEO CONTENT”, filed Jan. 7, 2009, which is hereby incorporated by reference in its entirety.

### BACKGROUND

Television receivers include many advanced features and often include menus to allow the user to control the operation of these advanced features as well as the general operation of the television receiver. These menus are often presented to the user in a full-screen mode. In other words, the entire screen or substantially the entire screen is filled with the menu information. Often, a user can manipulate multiple levels through the menu to make further selections. One problem with this scenario is that the user may decide to exit the menu and return to the television programming that they were previously viewing. However, the user typically has to manipulate back through each level of the menu before returning to the television programming, which can be time consuming and frustrating to the user.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a touch pad remote control usable in conjunction with the entertainment system described in FIG. 1.

FIG. 3 illustrates an embodiment of a display screen including an electronic programming guide.

FIG. 4 illustrates an embodiment of a display screen in which the user has selected the video output region of the display screen.

FIG. 5 illustrates an embodiment of a display screen including a full screen of television programming.

FIG. 6 illustrates an embodiment of another display screen presenting an electronic programming guide menu.

FIG. 7 illustrates another embodiment of a display screen presenting a DVR selection menu.

FIG. 8 illustrates an embodiment of a television receiver of FIG. 1.

FIG. 9 illustrates an embodiment of a process for presenting a video stream.

### DETAILED DESCRIPTION

The various embodiments described herein generally provide apparatus, systems and methods which facilitate the display of video content. More particularly, a television receiver displays menu information simultaneously with a video stream (e.g., television programming) in an integrated display screen. In other words, the television programming is downsized when the menu is launched to accommodate the presentation of the menu information. From within the display screen, the user can select the downsized television programming to close the menu information and return the television programming to a full screen mode. In short, the various embodiments described herein generally provide apparatus, systems and methods for selecting and displaying video content on a television receiver.

The concepts described herein will be described in the context of a television receiver having a touch pad remote control. However, it is to be appreciated that other types of remote controls and input devices may be used with the teachings described herein. For example, a remote control with directional buttons, a joystick, a keyboard, a keypad, a scrolling wheel or the like may be utilized to make selections and provide input.

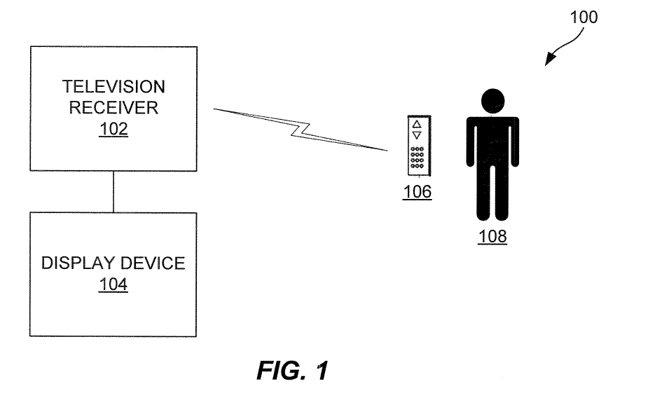

FIG. 1 illustrates an embodiment of an entertainment system 100. The entertainment system 100 presents content to a user 108. In at least one embodiment, the content presented to the user 108 includes an audio/video stream, such as a television program, movie or other recorded content and the like. The entertainment system 100 includes a television receiver 102, a display device 104 and a remote control 106. Each of these components is discussed in greater detail below. The entertainment system 100 may include other devices, components or elements not illustrated for the sake of brevity.

The television receiver 102 is operable to receive content from one or more content sources (not shown in FIG. 1) and output the received content for presentation by the display device 104. More particularly, the television receiver 102 is operable to receive, demodulate and output a television signal from a programming source, such as a satellite, cable, internet, terrestrial or other type of television transmission signal. The television receiver 102 may receive an audio/video stream in any format (e.g., analog or digital format). Likewise, the television receiver 102 may output the audio/video stream for presentation by the display device 104 in any type of format. In at least, one embodiment, the television receiver 102 is a set-top box (e.g., a satellite or cable television receiver or converter box) or other similar device that processes and provides one or more audio and/or video output streams to the display device 104 for presentation to the user 108.

The television receiver 102 may be further configured to output for display menus and other information that allow a user 108 to control the selection and output of content by the television receiver 102. For example, as described in further detail below, the television receiver 102 may output electronic programming guide menus for review by the user 108. The television receiver 102 may also output a preference menu or other types of menu for receiving input that specifies or controls the operation of the television receiver 102. Some menus outputted by the television receiver 102 may manipulate the output of content by the television receiver 102.

In at least one embodiment, the television receiver 102 includes an Integrated digital video recorder (DVR) operable to record video signals, corresponding with particular television programs, for subsequent viewing by the user 108. These programs may be selected for recording from within the electronic programming guide or may be inputted through other displayed menus, such as menus for setting manual recording timers. In at least one embodiment, the television receiver 102 displays a selection menu allowing the user 108 to select particular recordings for playback.

The display device 104 may comprise any type of device capable of receiving and outputting a video signal in any format. Exemplary embodiments of the display device 104 include a television, a computer monitor, a liquid crystal display (LCD) screen, a touch screen and a projector. The display device 104 and the television receiver 102 may be communicatively coupled through any type of wired or wireless interface. For example, the display device 104 may be communicatively coupled to the television receiver 102 through a coaxial cable, component or composite video cables, an HDMI cable, a VGA or SVGA cable, a Bluetooth or WiFi wireless connection or the like. In at least one embodiment, the television receiver 102 and the display device 104 may be integrated as a device combining the functionality of both, such as a television with an integrated cable receiver.

The remote control 106 may comprise any system or apparatus configured to remotely control the output of content by the television receiver 102. The remote control 106 may minimally include a transmitter, an input device (e.g., a keypad) and a processor or control logic for controlling the operation of the remote control 106. The remote control 106 may communicate commands to the television receiver 102 requesting to playback content, temporally move through content (e.g., fast-forward or reverse), adjust the volume, access electronic programming guides, set or edit recording timers, edit preferences of the television receiver and the like. In some embodiments, the remote control 106 may additionally be configured to remotely control the display device 104. The remote control 106 may communicate with the television receiver 102 and/or the display device 104 through any type of wireless communication medium, such as infrared (IR) signals or radio-frequency (RF) signals.

The remote control 106 may include any type of man-machine interlace for receiving input from the user 108. For example, the remote control 106 may include buttons for receiving input from the user 108. In at least one embodiment, the remote control 106 includes a touch pad for receiving input from the user 108.

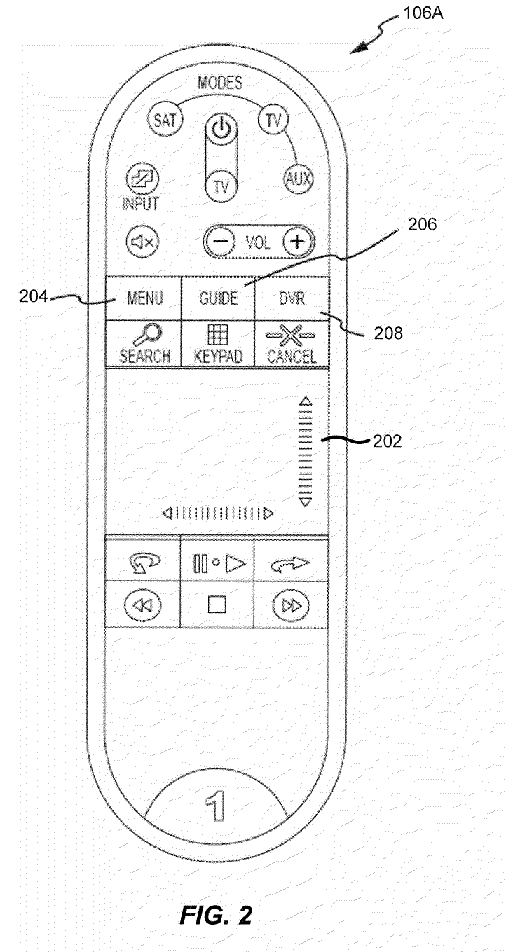

FIG. 2 illustrates an embodiment of a touch pad remote control 106A usable in conjunction with the entertainment system 100 described in FIG. 1. However, it is to be appreciated that other remote controls, including other components, input buttons and button layouts may also be used in conjunction with the teachings described herein. The remote control 106A includes a touch pad 202 for manipulating a cursor and/or selecting particular regions of a display screen outputted by the television receiver 102. The touch pad remote control 106A also includes a plurality of buttons for controlling various functionalities of the television receiver 102. For example, specific buttons, such as menu, guide, DVR, search, keypad, cancel, reverse, stop, forward, pause, jump back, jump forward and the like may used to manipulate the playback of content by the television receiver 102 or otherwise control the operation of the television receiver 102.

In the illustrated embodiment, buttons 204, 206 and 208 are utilized for opening various menus of the television receiver 102. Particularly, button 204 is operable for opening a preference menu of the television receiver. Button 206 is operable for opening an electronic programming guide of the television receiver 102 and button 208 is operable for opening a DVR menu of the television receiver 102. The touch pad 202 may be utilized for navigating the menus opened responsive to selection of each of the buttons 204-208. In at least one embodiment, the remote control 106A may include a trigger, utilized in association with the touch pad 202, for allowing the user 108 to input information associated with the menus displayed on-screen, e.g., for selecting on-screen buttons selected by a cursor navigated by the touch pad 202.

In at least one embodiment, the television receiver 102 initially displays video programming in a full screen mode or a substantially full screen mode. In other words, the video stream (e.g., television programming) is presented in the majority of display screen. The television programming that is presented may be either live, recorded or otherwise accessed locally by the television receiver 102.

When the user actuates one of the buttons 204, 206 or 208, the television receiver 102 responsively presents a menu corresponding with the selected button. More particularly, in at least one embodiment, the television receiver 102 responsively presents the corresponding menu and the television programming simultaneously in the same display screen. The television programming is downsized to accommodate presentation of the menu information.

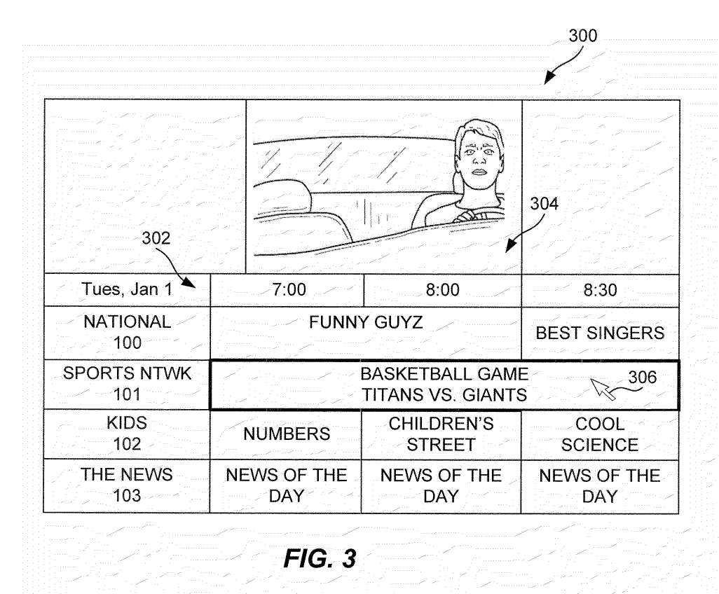

To locate television programs available for viewing, the user 108 utilizes the remote control 106 to request access to an electronic programming guide of the television receiver 102. For example, the user 108 may actuate the button 206, requesting to open the electronic programming guide. FIG. 3 illustrates an embodiment of a display screen 300 including an electronic programming guide 302. The display screen 300 also includes a video output 304 and a cursor 306. FIG. 3 will be discussed in reference to the entertainment system 100 described in FIGS. 1 and 2.

The electronic programming guide 302 graphically displays television programs for multiple channels and time slots in a grid format. In the illustrated embodiment, time slots are arranged along a horizontal axis of the electronic programming guide 302 and channels are arranged along a vertical axis of the electronic programming guide 302. The user 108 may scroll along both the horizontal and vertical axes of the electronic programming guide to locate programs of interest for recording. The user 108 may then provide input to the television receiver 102, via the remote control 106A, requesting to view and/or record particular programs listed in the electronic programming guide 302. For example, the user 108 may select a particular program by manipulating the position of the cursor 306 using the touch pad 202. It is to be appreciated that other formats of the electronic programming guide 302 may be utilized in accordance with the teachings described herein. For example, time slots may be arranged along the vertical axis and channels may be arranged along the horizontal axis of an electronic programming guide.

In the illustrated embodiment of FIG. 3, the electronic programming guide 302 is arranged in the bottom region of the display screen 300. The display screen 300 also includes the video output 304, which presents a video stream. The video output 304 displays presently viewed video content, such as a live television program or recorded content. In the illustrated embodiment, the video output 304 is arranged along a top region of the display screen 300 and is smaller than the electronic programming guide 302. However, it is to be appreciated that other screen layout arrangements may be utilized in accordance with the teachings described herein.

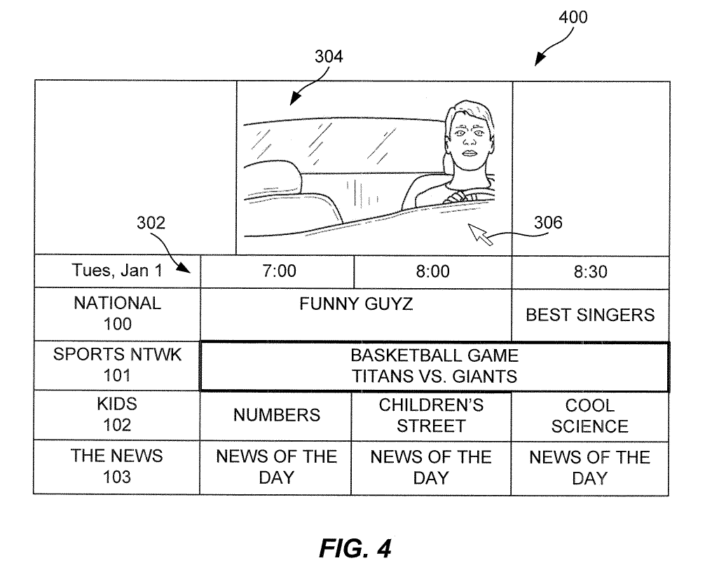

After opening the display screen 300, the user 108 may decide to return to a full screen mode for the television programming, in at least one embodiment, the user 108 may manipulate the cursor 306 to select the region of the display screen 300 occupied by the video output 304. FIG. 4 illustrates an embodiment of a display screen 400 in which the user has selected the video output 304 region of the display screen 400. Once the cursor 306 is positioned over the region of the display screen 300 corresponding with the video output 304, the user 108 may select the video output 304 using the remote control 106A. For example, the user 108 may press a trigger of the remote control 106A, double click the touch pad 202, press a button of the remote control 106A or the like to make the selection.

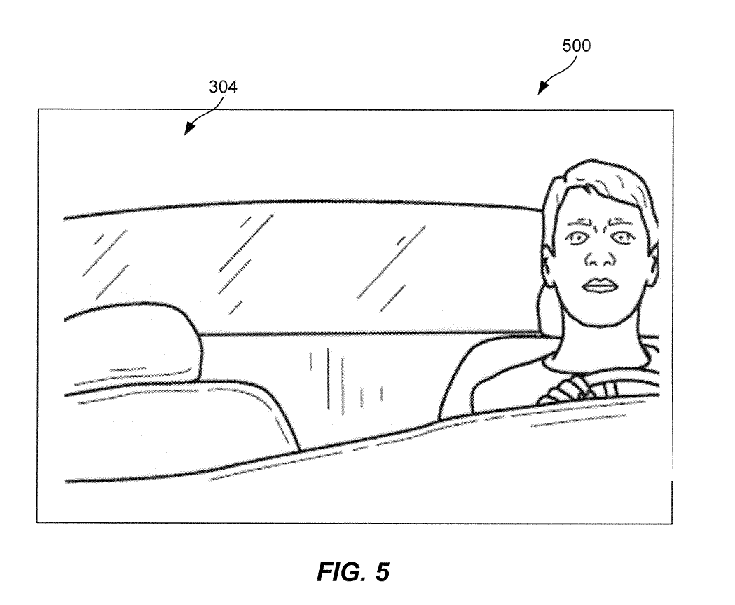

Responsive to the selection of the video output 304 region of the display screen 400, the television receiver 102 closes the electronic programming guide 302 and presents the video output 304 in a full screen mode. FIG. 5 illustrates an embodiment of a display screen 500 including a full screen of television programming. As illustrated in FIG. 5, the video output 304 is arranged in substantially the entire display screen 500. In other words, the video output 304 covers the region of the screen previously allocated to the electronic programming guide 302 (see FIG. 3) as well as the region previously allocated to the downsized video output 304.

Thus, the user 108 can return the television programming to a full screen mode by selecting the video output 304 from within a display screen 400 (see FIG. 4). This is particularly useful when the user 108 has navigated several levels within a particular menu screen and wants to easily return to a full screen mode without navigating through each level of the menu. This technique can also be applied to other types and configurations of display menus. Essentially, any type of menu outputted by a television receiver 102 may be used in conjunction with the teachings described herein.

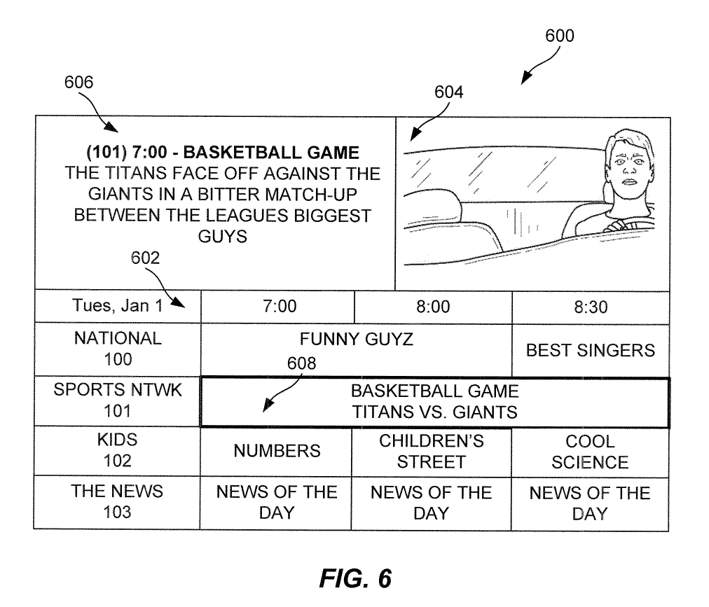

FIG. 6 illustrates an embodiment of another display screen 600 for presenting an electronic programming guide menu. The display screen 600 will be described in reference to the entertainment system 100 described in FIGS. 1-2. The display screen 600 is divided into three regions. A first region of the display screen presents an electronic programming guide 602. A second region of the display screen 600 presents a video output 604 and a third region of the display screen 600 presents an informational panel 606 including information associated with the electronic programming guide 600.

As the user 108 scrolls through the electronic program guide 602, particular portions of the display screen 600 may be highlighted by the user 108. More particularly, cells of the grid of the electronic programming guide 602, such as a cell corresponding with a particular channel or a cell corresponding with a particular television program, may be selected by the user 108. For example, the user 108 may utilize arrow keys and an enter button of the remote control 106 to highlight and select the cell of the grid corresponding with the “Basketball Game” television program. Responsive to the user 108 highlighting a particular cell with the cursor 608, the television receiver 102 outputs the informational panel 606 associated with the highlighted program.

The user 108 may further navigate the cursor 608, using the remote control 106, to select the region of the display screen corresponding with the video output 604. As previously described, the television receiver 102 responsively closes the electronic programming guide 602 and the informational panel 606. Thus, the video output is presented by the television receiver 102 in a full screen mode.

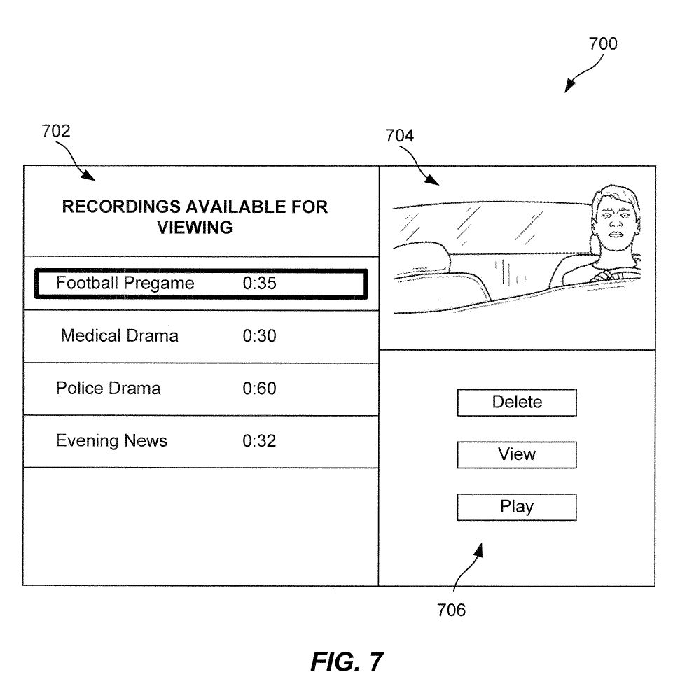

FIG. 7 illustrates another embodiment of a display screen 700 presenting a DVR selection menu. In at least one embodiment, the display screen 700 may be opened responsive to the user pressing the button 208 (see FIG. 2). The display screen 700 will be discussed in reference to the entertainment system 100 described in FIGS. 1-2.

The display screen 700 is comprised of three regions 702, 704 and 706. The first region 702 includes a listing of recorded television programming available for viewing by the user 108. The second region 704 includes a video output, which is similar to the video output 304 described above. The third region 706 includes a plurality of buttons used to select recorded programming for playback. Like the embodiments described above, the user 108 can select the second region 704 to enlarge the video output to full screen, closing the panels corresponding with the first region 702 and the third region 706. Thus, the video output is presented in the first region 702, the second region 704 and the third region 706 of the display screen 700.

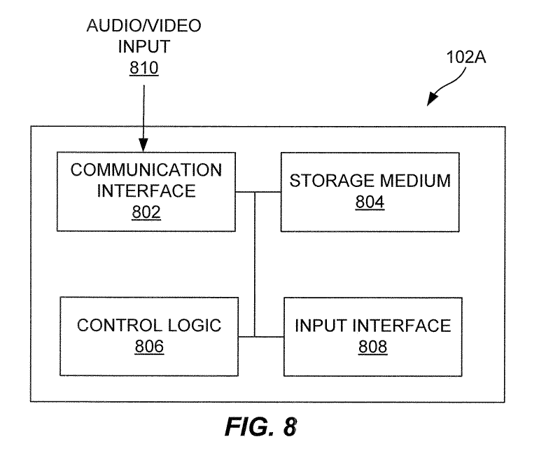

FIG. 8 illustrates an embodiment of a television receiver of FIG. 1. FIG. 8 will be discussed in reference to the entertainment system 100 illustrated in FIG. 1. The television receiver 102A includes a communication interface 802, a storage medium 804, control logic 806 and an input interface 808. Each of these components will be discussed in greater detail below. The television receiver 102A may include other elements, components or devices which are not illustrated for the sake of brevity.

The communication interface 802 is operable to receive an audio/video input 810 from a content source. More particularly, in at least one embodiment, the communication interface 802 receives and tunes a television signal including television programming. The communication interface 802 may receive an over-the-air broadcast, a direct broadcast satellite signal, a cable television signal or an internet protocol television (IPTV) signal and tune the audio/video input 810 to extract the selected television programming. In at least one embodiment, the communication interface 802 may comprise multiple tuners, utilized by the television receiver 102A to present and/or record multiple television programs simultaneously.

The storage medium 804 is operable to store electronic programming guide data and other system information utilized by the television receiver 102A. The storage medium 804 may comprise any type of non-volatile memory appropriate for storing data associated with the television receiver 102A. Exemplary storage mediums 804 include semi-conductor memory, disk drives (e.g., magnetic memory) and flash memory. In some embodiments, the television receiver 102A may optionally include DVR functionality to record and persistently store video signals received by the television receiver 102A. In at least one embodiment, the storage medium 804 may be utilized to store video previews, advertising information and the like for on-demand viewing by the user 108. In some embodiments, a disk drive or other storage medium may be internally located within the television receiver 102A. In other embodiments, a disk drive or other storage medium may be located externally with respect to the television receiver 102A. The television receiver 102A may also utilize a combination of internal and external storage mediums 804 for storage of video signals and other data.

The control logic 806 is operable to control the operation of the television receiver 102A. The control logic 806 may be a single processing device or a plurality of processing devices that cooperatively operate to control the operation of the television receiver 102A. The control logic 806 may include various components or modules for processing and outputting audio/video content. Exemplary components or modules for processing audio/video content include a demodulator, a decoder, a decompressor, a conditional access module and a transcoder module.

The control logic 806 is operable to receive the audio/video input 810, received via the communication interface 802, and generate an audio/video output stream based on the audio/video input 810 for display by an associated display device 104. An audio/video output stream is outputted to the display device 104 (see FIG. 1) for presentation to the user 108. The control logic 806 may incorporate circuitry to output the audio/video streams in any format recognizable by the display device 104, including composite video, component video, Digital Visual Interface (DVI) and High-Definition Multimedia Interlace (HDMI). The control logic 806 may also incorporate circuitry to support multiple types of these or other audio/video formats. In at least one embodiment, as described above, the television receiver 102A may be integrated with the display device 104, and the control logic 806 may be operable to control the presentation of the audio/video output stream. In at least one embodiment, the control logic 806 is operable to coordinate storage of the audio/video input 810 onto the storage medium 804. The control logic 806 is also operable to retrieve stored video content to generate an audio/video output stream for display by the display device 104. To coordinate the storage of the audio/video input 810, the control logic 806 is operable to receive user input requesting to record one or more television programs. Responsively, the control logic 806 sets recording timers for the indicated television programs.

The input interface 808 is operable to wirelessly receive data from the remote control 106. The Input interface 808 may communicate with the remote control 106 utilizing any type of IR or RF communication link. In at least one embodiment, the input interface 808 receives a key code from the remote control 106 and responsively provides the key code to the control logic 806. In some embodiments, the input interface 808 may receive positional information from a scrolling device of the remote control 106, e.g., a touch pad, scroll wheel or the like. Some of the data received by the input interface 808 may request to view electronic programming guide data, menus and the like.

In at least one embodiment, the control logic 806 is operable to receive user input requesting to display a menu, such as an electronic programming guide. Responsive to the user input, the control logic 806 outputs a display screen, for display by the display device 104, that includes the electronic programming guide data displayed simultaneously with a video stream, such as live or recorded television programming outputted by the television receiver 102 for display to the user 108. In other words, the display screen includes the menu in a first region of the display screen and the video output in a second region of the display screen.

After outputting a programming guide for display to the user 108, the control logic 806 receives user input selecting a region of the display screen corresponding with the video output. The control logic 806 processes the user input and modifies the display screen to display the video output in both the first and second regions of the display screen, thus, closing the menu originally displayed in the display screen.

Those of ordinary skill in the art will appreciate that the various functional elements 802 through 808 shown as operable within the television receiver 102A may be combined into fewer discrete elements or may be broken up into a larger number of discrete functional elements as a matter of design choice. Thus, the particular functional decomposition suggested by FIG. 8 is intended merely as exemplary of one possible functional decomposition of elements within the television receiver 102A.

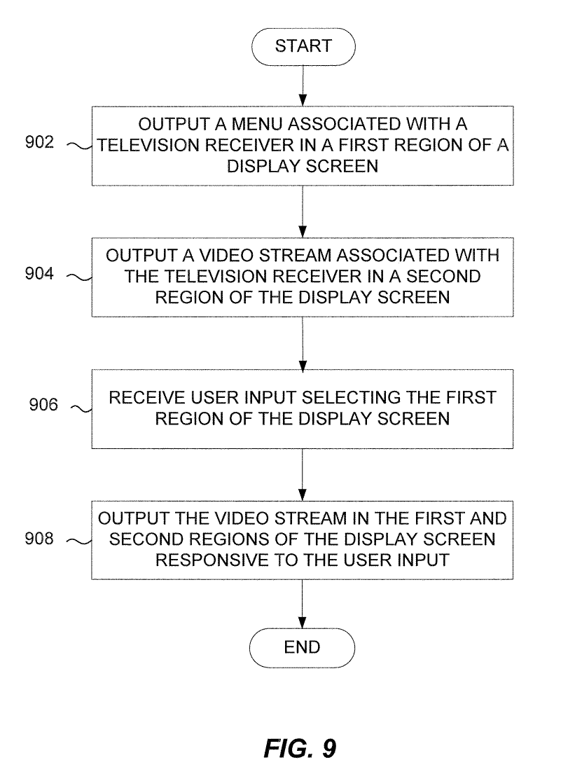

FIG. 9 illustrates an embodiment of a process for presenting a video stream. The process of FIG. 9 may include other operations not illustrated for the sake of brevity. The process includes outputting a menu associated with a television receiver in a first region of a display screen (operation 902). The process further includes outputting a video stream associated with the television receiver in a second region of the display screen (operation 904). The process further includes receiving user input selecting the second region of the display screen (operation 906). Responsive to the user input, the process further includes outputting the video stream in the first and second regions of the display screen (operation 908).

Although specific embodiments were described herein, the scope of the invention is not limited to those specific embodiments. The scope of the invention is defined by the following claims and any equivalents therein.

We claim:

1. A method for presenting a video stream, the method comprising:
outputting a menu associated with a television receiver in a first region of a display screen;
outputting a video stream associated with the television receiver in a second region of the display screen;
receiving user input selecting the second region of the display screen; and
outputting the video stream in the first and second regions of the display screen responsive to the user input.

2. The method of claim 1, wherein outputting the menu further comprises:
outputting an electronic programming guide in the first region of the display screen.

3. The method of claim 1, wherein the television receiver comprises a digital video recorder and wherein outputting the menu further comprises:
outputting a selection menu of programming recorded by the digital video recorder for selective playback.

4. The method of claim 1, wherein outputting the menu further comprises:
outputting a preference menu of the television receiver.

5. The method of claim 1, wherein the video stream comprises live television programming received by the television receiver from an external programming source.

6. The method of claim 1, wherein the television receiver comprises a digital video recorder and the video stream comprises programming recorded by the digital video recorder.

7. The method of claim 1, wherein the first region is larger than the second region.

8. The method of claim 1, wherein receiving user input selecting the second region of the display screen further comprises:
receiving user input through a cursor controlled via a touch pad remote control associated with the television receiver.

9. The method of claim 1, wherein receiving user input selecting the second region of the display screen further comprises:
receiving user input through a cursor controlled via a directional keypad of a remote control associated with the television receiver.

10. A television receiver comprising:
a communication interface configured to receive television programming from a programming source;
an input interface communicatively coupled to a television remote control; and
control logic communicatively coupled to the communication interface and the input, interface, the control logic operable to:
output a menu in a first region of a display screen, the menu associated with receiving first user input controlling the reception of the television programming by the television receiver:
output a video stream in a second region of the display screen;
receive second user input selecting the second region of the display screen; and
output the video stream in the first and second regions of the display screen responsive to the second user input.

11. The television receiver of claim 10, wherein the menu comprises an electronic programming guide configured to display information regarding the television programming received by the programming source.

12. The television receiver of claim 10, wherein the menu comprises a preference menu of the television receiver.

13. The television receiver of claim 10, wherein the video stream comprises live television programming received by the communication interface from the programming source.

14. The television receiver of claim 10, further comprising:
a storage medium;
wherein the control logic is configured to store the television programming to the storage medium;
wherein the video stream comprises the recorded television programming.

15. The television receiver of claim 10, wherein the first region is larger than the second region.

16. The television receiver of claim 10, wherein the remote control comprises a touch pad and wherein a user selects the second region by manipulating a cursor using the touch pad.

17. The television receiver of claim 10, wherein the remote control comprises at least one directional button and wherein a user selects the second region by manipulating a cursor using the directional button.

18. A television receiver comprising:
a communication interface that receives television programming from a programming source;
an input interface communicatively coupled to a television remote control; and
control logic communicatively coupled to the communication interface and the input interface, the control logic operable to:
output a display screen, for display by an associated display device, the display screen comprising a first region displaying an electronic programming guide grid including information regarding the television programming, a second region displaying information associated with the electronic programming guide grid and a third region displaying a video stream;
receive user input, from the television remote control, selecting the third region of the display screen; and
modify the display screen responsive to the user input, the modified display screen including the video stream in the first, second and third regions.

19. The television receiver of claim 18, wherein the video stream comprises live television programming received by the communication interface from the programming source.

20. The television receiver of claim 18, wherein the remote control comprises a touch pad and wherein a user selects the second region by manipulating a cursor using the touch pad.
